(19) United States
(12) Patent Application Publication
(10) Pub. No.: US 2026/0352040 A1
(43) Pub. Date: Nov. 5, 2026

(54) Stator Lamination and Laminated Stator Core

(71) Applicant: Hilti Aktiengesellschaft, Schaan (LI)

(72) Inventor: Christian RUFF, Stadtbergen (DE)

(21) Appl. No.: 19/121,348

(22) PCT Filed: Oct. 10, 2023
(86) PCT No.: PCT/EP2023/078055

§ 371 Date: Apr. 15, 2025

(30) Foreign Application Priority Data
Oct. 24, 2022 (EP) 22203251.8

(51) Int. Cl. H02K 1/14

(52) U.S. Cl. CPC H02K 1/14

(57) ABSTRACT

An apparatus for a laminated stator core of a brushless DC motor includes a stator lamination where the stator lamination is completely closed in a circumferential direction and has a plurality of star elements. Two adjacent star elements of the plurality of star elements are connected to one another by a respective bridge where each of the respective bridges is narrowed in a radial direction by a respective groove.

### BACKGROUND AND SUMMARY OF THE INVENTION

The present invention relates to a stator lamination for a laminated stator core of a brushless DC motor. The stator lamination is completely closed in the circumferential direction and has a plurality of star elements, wherein two adjacent star elements are in each case connected to one another by a bridge.

Stator laminations of the type mentioned at the beginning are known in principle from the prior art. EP 2 507 896 B1 discloses methods for producing a stator for an electric motor, in which a number of stator laminations is stacked to form a star-shaped laminated core consisting of stator laminations closed in the circumferential direction and having individual teeth connected to one another by pole shoe webs and of stator laminations open in the circumferential direction and having individual teeth spaced apart to form a gap on the pole shoe side.

It is the object of the present invention to specify a stator lamination that provides the basis for a laminated stator core that can be produced in a relatively simple and low-cost manner.

The object is achieved by the fact that the bridge is narrowed in the radial direction by means of at least one groove. It has proven advantageous if the groove extends in the axial direction over the entire thickness of the stator lamination.

The invention incorporates the insight that laminated stator cores in the prior art must have stator laminations of different types to achieve certain magnetic properties, that is to say must have both stator laminations that are closed in the circumferential direction and stator laminations that are open in the circumferential direction. Accordingly, punching tools of different types are employed, making the production of laminated stator cores relatively expensive.

As a departure from the prior art, the stator lamination according to the invention is used to provide the basis for a laminated stator core which can comprise a plurality of identical stator laminations, for example.

In a particularly preferred embodiment, at least one of the bridges has a groove which is open inward in the radial direction. Open inward in the radial direction should be understood, in particular, to mean that the groove is open in the direction of a central point of the stator lamination. In another preferred embodiment, at least one of the bridges has a groove which is open outward in the radial direction.

It has proven advantageous if a residual portion of a first bridge which is left by the groove is at a different radial distance from a central point of the stator lamination than a residual portion of a second bridge which is left by the groove.

In another preferred embodiment, at least one of the bridges has a groove which is open inward in the radial direction and a groove which is open outward in the radial direction. It has proven advantageous if a residual portion of this bridge which is left by the grooves is at a different radial distance from a central point of the stator lamination than a residual portion of the first and second bridges which is left by the groove.

It has proven advantageous if the stator lamination has pairs of bridges of the same design. In a particularly preferred embodiment, the pairs of bridges of the same design are each arranged diametrically with respect to one another. In another preferred embodiment, the groove is arranged centrally between two adjacent star elements with respect to the circumferential direction. In a particularly preferred embodiment, the bridge is narrowed by at least 50 percent in the radial direction by the groove.

In another preferred embodiment, the stator lamination is provided for use in a laminated stator core of a three-phase brushless DC motor. For this purpose, the stator lamination preferably has exactly six star elements and exactly six bridges. It has proven advantageous if exactly two of the total of six bridges have just one groove each, wherein these grooves are open inward in the radial direction. It has furthermore proven advantageous if exactly two of the total of six bridges have just one groove each, wherein these grooves are open outward in the radial direction. As a further preference, exactly two of the total of six bridges have exactly two grooves each, wherein-for each bridge-exactly one groove is open inward in the radial direction and exactly one groove is open outward in the radial direction.

In respect of the laminated stator core, the object is achieved by a laminated stator core which has a plurality of identical stator laminations as described above stacked one on top of the other in the axial direction and, in particular, comprises a plurality of such stator laminations.

It has been found that the laminated stator core according to the invention has a number of mechanical and magnetic advantages. From a mechanical point of view, it should be emphasized that there is a mechanical connection between respective adjacent star elements in each stator lamination plane. This leads to more uniform force distribution of the compressed assembly. Depending on the rotation of the stator laminations relative to one another, a rotor space can be sealed off or at least the penetration of particles above a certain particle size can be prevented. It has been found that the laminated stator core according to the invention provides the basis, from a magnetic point of view, for a slightly higher average torque with lower fluctuations in the torque and lower iron losses. The forces prevailing between the star and the yoke ring are uniformly distributed for all the stator laminations.

It has proven particularly advantageous if two adjacent stator laminations are stacked incongruently one on top of the other. In a particularly preferred embodiment, the laminated stator core is provided for use in a three-phase brushless DC motor. In this case, it has proven advantageous if two adjacent stator laminations are rotated by 120 degrees relative to one another, in particular in each case by 120 degrees relative to one another. A rotation can be a quotient or a multiple of the quotient of 360 degrees and the number of star elements. In the example of exactly six star elements, therefore, 60 degrees, 120 degrees etc. In the context of the present invention, a rotation should be understood, in particular, to mean a rotation around an imaginary axis of rotation of a rotor to be arranged in the laminated stator core. As an alternative or in addition, one or more of the identical stator laminations stacked one on top of the other in the axial direction can be turned through 180 degrees (“upside down”) when inserted into the laminated stator core. It has proven advantageous if the laminated stator core is free from individual star elements, that is to say, in particular, free from star elements which are not connected on both sides to a bridge in the same plane.

The invention likewise presents a brushless DC motor, in particular for an electric power tool, wherein the brushless DC motor has a laminated stator core of the type described above.

Further advantages will become apparent from the following description of the figures. A particularly preferred exemplary embodiment of the present invention is illustrated in the figures. The figures, the description, and the claims contain numerous features in combination. A person skilled in the art will expediently also consider the features individually and combine them to form sensible further combinations.

Identical and similar components are denoted by the same reference signs in the figures.

### BRIEF DESCRIPTION OF THE DRAWINGS

FIG. 1 shows a preferred exemplary embodiment of a stator lamination;

FIG. 2 shows a preferred exemplary embodiment of a laminated stator core; and

FIG. 3 shows a sectional illustration of the laminated stator core of FIG. 2.

### DETAILED DESCRIPTION OF THE DRAWINGS

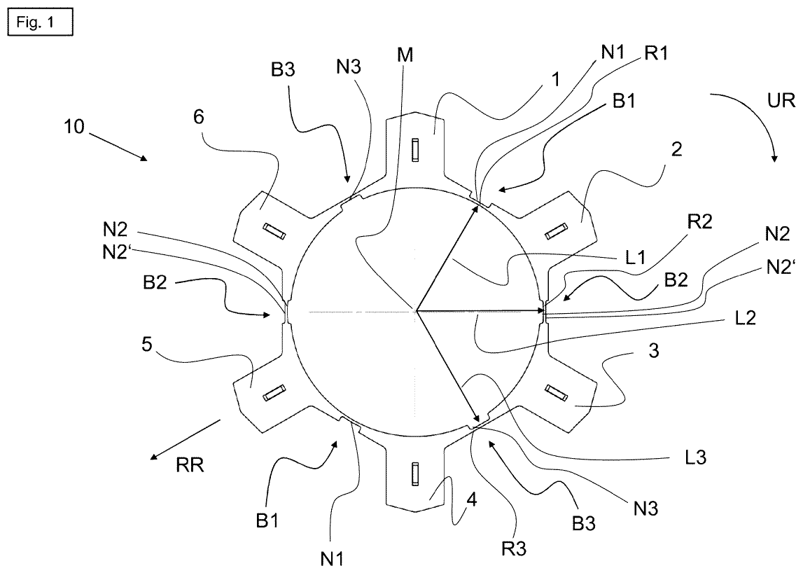

A preferred exemplary embodiment of a stator lamination 10 according to the invention is shown in FIG. 1. The stator lamination 10 is completely closed in the circumferential direction UR and has six star elements 1, 2, 3, 4, 5, 6, for example. Two adjacent star elements are in each case connected to one another by a bridge B1, B2, B3. A total of six bridges is provided. This enables the stator lamination 10 to serve as a basis for a laminated core of a three-phase brushless DC motor, for example.

As can be seen from FIG. 1, the stator lamination 10 has pairs of bridges B1, B2, B3 of the same design, which are each arranged diametrically with respect to one another. Accordingly, the stator lamination 10 thus has three different “bridge types”. Each of the bridges B1, B2, B3 is narrowed in the radial direction RR by means of at least one groove.

A first bridge B1 is provided with a groove N1 which is open outward in the radial direction RR. Another bridge B3 has a groove N3 which is open inward in the radial direction RR, i.e., is open in the direction of a central point M of the stator lamination 10. The bridge B2 is characterized in that it has both a groove N2 open inward in the radial direction RR and a groove N2′ open outward in the radial direction RR. The grooves N1, N2, N2′, N3 are each arranged centrally between two adjacent star elements with respect to the circumferential direction UR. The grooves N1, N2, N2′, N3 extend over the entire thickness of the stator lamination 10 with respect to the axial direction of the stator lamination 10.

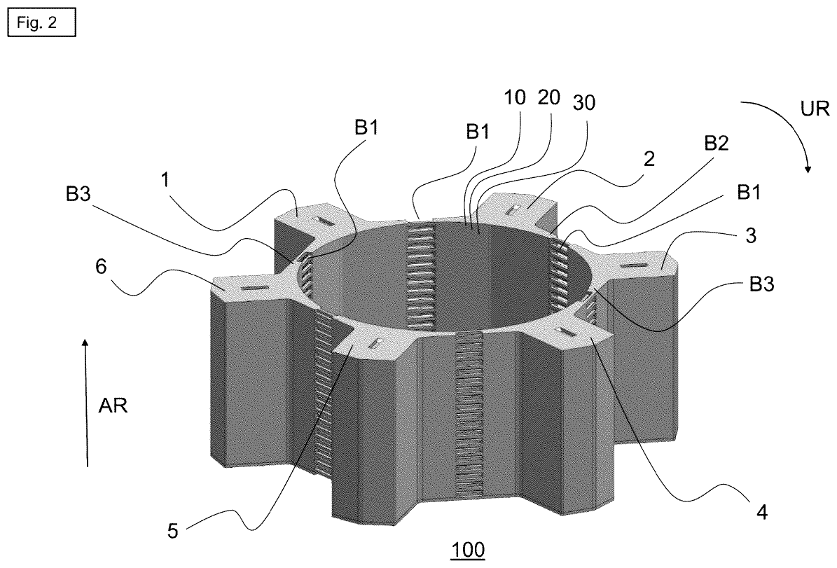

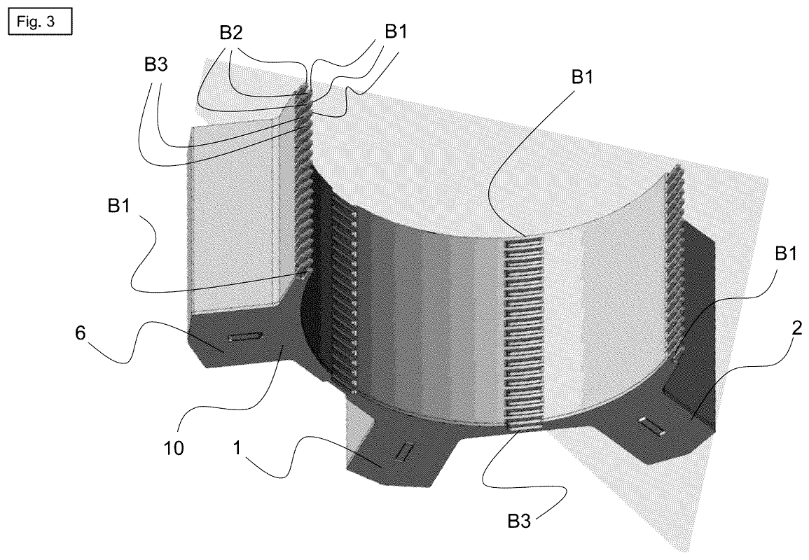

By virtue of the grooves N1, N2, N2′, N3, so-called residual portions R1, R2, R3 of the bridges B1, B2, B3 remain and, by means of these, the stator lamination 10 continues to be completely closed in the circumferential direction UR. By structural positioning of the residual portions R1, R2, R3 at various distances from the central point M of the stator lamination 10 and subsequent rotation of each stator lamination in the laminated stator core (cf. FIGS. 2 and 3), it is possible to create a laminated stator core which is electromagnetically and mechanically optimized.

In the exemplary embodiment under consideration, a residual portion R1 of the first bridge B1 left by the groove N1 is at a different, namely a shorter, radial distance L1 from the central point M of the stator lamination 10 than a residual portion R2 of bridge B2 left by groove N2. The radial distance of the residual portion R2 in FIG. 1 is denoted by L2. Once again, the residual portion R2 of bridge B2 left by groove N2 is at a shorter radial distance L2 from the central point M of the stator lamination 10 than a residual portion R3 of bridge B3 left by groove N3. The radial distance of the residual portion R3 in FIG. 1 is denoted by L3. In the exemplary embodiment in FIG. 1, the following accordingly applies: L1<L2<L3.

FIG. 2 shows a laminated stator core 100 which has a plurality of identical stator laminations 10, 20, 30 stacked one on top of the other in the axial direction AR. These are stator laminations as per FIG. 1. For reasons of simplified illustration, only the first three stator laminations 10, 20, 30 are provided with reference signs.

As can be seen from FIG. 2, the stator laminations 10, 20, 30 can be stacked in a manner rotated relative to one another (with respect to the axis of rotation of the rotor, not illustrated here) in such a way that two adjacent stator laminations, i.e., stator laminations 10 and 20 or 20 and 30 are incongruent with respect to one another. In other words, there are always two bridges of different types lying one above the other in each case.

In the present example, the stator laminations 10, 20, 30 are each rotated by 120 degrees in the circumferential direction UR (in the direction of view from the top down). That is to say that the first bridge B1, which is arranged between the first star element 1 and the second star element 2 of the first stator lamination 10, is at the top in FIG. 2. To the left of this with respect to the circumferential direction UR, in a second plane-i.e., in the second stator lamination 20-the first bridge (bridge of the first type) is likewise denoted as B1. This is the first bridge which is situated between the fourth star element 4 and the fifth star element 5 of the stator lamination. To the right of the bridge B1 with respect to the circumferential direction UR, in a third plane-i.e., in the third stator lamination 30-the first bridge (bridge of the first type) is likewise denoted as B1. This is the first bridge which is once again situated between the first star element 1 and the second star element 5 of the stator lamination.

Finally, FIG. 3 shows a vertical section through the laminated stator core 100 of FIG. 2, wherein-in relation to the first stator lamination 10, which is shown at the bottom here-the section runs through the bridges B1 (bridge of the first type) situated diametrically with respect to one another.

It is clearly apparent that two adjacent stator laminations are rotated by 120 degrees relative to one another and that in each case two bridges of different types always lie one above the other. Since the stator laminations are rotated by 120 degrees in each plane, the stacking sequence is repeated by every fourth stator lamination. In other words, the first, fourth, seventh, etc. stator lamination would be congruent with each other in an imaginary projection.

### LIST OF REFERENCE CHARACTERS

1, 2, 3, 4, 5, 6 Star elements
10, 20, 30 Stator lamination
100 Laminated stator core
AR Axial direction
M Central point
B1, B2, B3 Bridges
N1, N2, N2′, N3 Grooves
R1, R2, R3 Residual portion
RR Radial direction
UR Circumferential direction

1.-12. (canceled)

13. An apparatus for a laminated stator core of a brushless DC motor, comprising:
a stator lamination, wherein the stator lamination is completely closed in a circumferential direction and has a plurality of star elements, wherein two adjacent star elements of the plurality of star elements are connected to one another by a respective bridge, and wherein each of the respective bridges is narrowed in a radial direction by a respective groove.

14. The apparatus as claimed in claim 13, wherein the respective groove of one of the respective bridges is open inward in the radial direction.

15. The apparatus as claimed in claim 13, wherein the respective groove of one of the respective bridges is open outward in the radial direction.

16. The apparatus as claimed in claim 13, wherein a first residual portion of a first one of the respective bridges which is left by the respective groove is at a different radial distance from a central point of the stator lamination than a second residual portion of a second one of the respective bridges which is left by the respective groove.

17. The apparatus as claimed in claim 13, wherein the respective groove of one of the respective bridges is open inward in the radial direction and wherein the one of the respective bridges has an additional groove which is open outward in the radial direction.

18. The apparatus as claimed in claim 17, wherein a residual portion of the one of the respective bridges which is left by the respective groove and the additional groove is at a different radial distance from a central point of the stator lamination than a respective residual portion of a second one of the respective bridges left by the respective groove and a respective residual portion of a third one of the respective bridges left by the respective groove.

19. The apparatus as claimed in claim 13, wherein two of the respective bridges have a same configuration.

20. The apparatus as claimed in claim 19, wherein the two of the respective bridges that have the same configuration are disposed diametrically with respect to one another.

21. The apparatus as claimed in claim 13, wherein the respective groove of the respective bridge is disposed centrally between the two adjacent star elements with respect to the circumferential direction.

22. A laminated stator core for a brushless DC motor, comprising:
a plurality of apparatuses as claimed in claim 13, wherein the plurality of apparatuses are stacked one on top of another in an axial direction.

23. The laminated stator core as claimed in claim 22, wherein two adjacent stator laminations of the plurality of apparatuses are stacked incongruently.

24. A brushless DC motor, comprising:
a laminated stator core, wherein the laminated stator core comprises:
a plurality of apparatuses as claimed in claim 13, wherein the plurality of apparatuses are stacked one on top of another in an axial direction.
